(19) United States
(12) Patent Application Publication
(10) Pub. No.: US 2002/0194925 A1
(43) Pub. Date: Dec. 26, 2002

(54) Method and a device for improving the signal to noise ratio

(76) Inventors: Kenneth Grefve, Vasteras (SE); Jorgen Bosson, Vasteras (SE)

Correspondence Address: DYKEMA GOSSETT PLLC, Third Floor West, Franklin Square, 1300 I Street, N.W., Washington, DC, 20005-3306, US

(21) Appl. No.: 10/083,679

(22) Filed: Feb. 27, 2002

Related U.S. Application Data
(60) Provisional application No. 60/272,062, filed on Mar. 1, 2001.

(51) Int. Cl. G01L 1/00

(52) U.S. Cl. 73/760

(57) ABSTRACT

Present invention relates to a method and a device 145 for improving the signal-to-noise ratio (S/N) in a system 40 for measuring flatness of a strip 1 of rolled material, comprising 5 a measuring roll 2 having a number of said measuring devices 22 for force/pressure registration. Said devices 22 generate measurement output signals Uₚ₁, depending on the contact between the strip and the measuring roll. The invented device 145 determines and generates time slots having a determined time length, synchronizes said time slots to the appearance of force components on an input of at least one quantity processor 62 of said signal processors 60 and controls at least one of said quantity processors 62 to be open for registration of an incoming force component signal during said time slot and to be closed until the next successive time slot appears. The present invention also provides a computer program product and a flatness determination signal for accomplishing said objects of the invention.

### TECHNICAL AREA

The invention relates continuous production of substantially long and flat sheet or strip of material such as copper, steel or aluminum.

More particularly, the invention relates to a system for measuring flatness and a flatness determination signal, and moreover a method, a device and a computer program product for improving the signal-to-noise ratio during the flatness measuring for use in a rolling mill where strip is processed in a rolling operation.

### BACKGROUND ART

In the rolling of strip and sheet materials it is common practice to roll a material to desired dimensions in a rolling mill stand and then normally feed the resulting strip to a coiler. In the coiler, the strip is wound up into a coil. Such coils are then taken off the coiler and after some time has elapsed moved on to subsequent processes such as annealing, slitting, or surface treatment processes and other processes.

The tension in the strip between a mill stand and a coiler is carefully monitored and it is known to measure tension distribution across a strip in order to regulate the flatness of the rolled material. In U.S. Pat. No. 3,481,194 Sivilotti and Carlsson disclose a strip flatness sensor. It comprises a measuring roll over which the strip passes between a mill stand and, for example, a coiler. The measuring roll detects the pressure from the strip at several points across the width of the strip. The pressure represents a measure of the tension in the strip. The measurements of tension in the strip result in a map of flatness in each of several zones across the width of the strip. U.S. Pat. No. 4,400,957 discloses a strip or sheet mill in which tensile stress distribution is measured to characterise flatness. The measures of flatness are compared to a target flatness and a difference between measured flatness and target flatness is calculated, as a flatness error. The flatness error is fed back via a control unit to the actuators of the mill stand, so as to regulate and control flatness in the strip in order to approach a zero flatness error.

The wrap angle is an important value when calculating other values of interest. The wrap angle is depending on the radius of the coil on the coiler. The wrap angle will change when the radius of the coil is growing and, therefore, the value of the wrap angle has to be adjusted during the process. It is used for calculating the Distributed Force per sensor on the measuring roll. The quantity strip tension is another calculated value corresponding to the force of the strip against the measuring roll. Strip tension is an important quantity for determining the mean value force on the roller and on each measuring device.

Wrap angle, Distributed Force per sensor, Strip tension and Flatness per zone across the width of the strip during rolling is determined by means of the strip tension measurement load cells and a measuring roll, which has a number of force/pressure sensors that are situated in a certain pattern on said roll. The measuring roll is divided in zones. A zone is an area on the surface of the cylindrical roll between two planes that are perpendicular relatively the rotational axle of the roll. Each measurement zone has at least one sensor/transducer and each sensor/transducer generates a measurement output signal, a force signal, depending on the pressure of the flat sheet on to the transducer/sensor.

However, the output signal from each sensor includes a force component signal and some noise. The force component signal is 3 only generated during the short contact between the strip and the measuring device, but the noise is generated by the measuring device constantly. Throughout each lap of the measuring roll, the noise will be both negative and positive. There will be a noise contribution that could be summed for each new lap of the measuring roll. Said noise has to be reduced to achieve a better signal-to-noise ratio before any further signal processing is carried out in the system.

### SUMMARY OF THE INVENTION

It is an object of the invention to suggest a method and advice for reducing the noise and increase the signal-to-noise ratio in a system for flatness measuring system.

This object is achieved by limiting the registration periods to the periods when force component signals are expected and adjusting the length of said periods to the length of the incoming force component signals.

The invention may be described as a method and a device for improving the signal-to-noise ratio (S/N) in a system for measuring flatness of a strip of rolled material, said system comprises at least one signal processor for determining said flatness and a measuring roll. The invented device determines and generates a time slot having a determined time length, synchronises said time slot to the appearance of a force component on an input of at least one signal processor and controls at least one of said signal processors to be open for registration of an incoming force component signal during said time slot and to be closed until the next successive time slot appears.

In more detail, the invented method for improving the signal-to-noise ratio (S/N) in a system for measuring flatness of a strip of rolled material, wherein said system comprises at least one signal processor for determining said flatness and a measuring roll, having a number of measuring devices for force/pressure registration. Said measuring devices generate measurement output signals depending on the contact between the strip and the measuring roll, wherein each measurement signal comprises a force component signal and a noise signal component. The invented method comprises following steps:

determining a time length and generating a time slot having said determined time length;

synchronising said time slot to the appearance of a force component on an input of at least one quantity processor of said signal processor;

controlling at least one quantity processor to be open for registration of an incoming force component signal during said time slot and be closed until the next successive time slot appears.

In more detail, the invented device for improving the signal-to-noise ratio (S/N) in a system for measuring flatness of a strip of rolled material, wherein said system comprises at least one signal processor for determining said flatness and a measuring roll, having a number of measuring devices for force/pressure registration. Said measuring devices generate measurement output signals depending on the contact between the strip and the measuring roll, wherein said measurement output signal comprises a force component signal and a noise signal component. The invented device comprises a position synchronisation processor, said processor being arranged for determining a time length and generating a time slot having said determined time length, for synchronising said time slot to the appearance of a force component signal on an input of at least one quantity processor of said signal processor and for controlling at least one quantity processor to be open for registration of an incoming force component during said time slot and be closed until the next successive time slot appears.

Further, the invention provides an invented system for measuring flatness of a strip of rolled material involving the invented method and comprising the invented device for 5 improving the signal-to-noise ratio (S/N).

The present invention also provides a computer program product and a flatness determination signal for accomplishing said objects of the invention.

The main advantage of the invention is that it improves the signal-to-noise ratio.

Another advantage is that the system is more reliable even though one or more of the measurement output signals is temporarily lost.

Further one advantage is that the system automatically adjusts and uses a “fresh” and correct time length of the time slot and therefore the system will provide a more correct value of the flatness and other force quantities.

Another advantage is that the system is not so complex and expensive as prior art devices. It is therefore an advantage of the invention that it provides a method, a computer program product, a computer data signal and a device for determining the wrap angle without using information and/or data generated by tensiometer load cells that are fixed at the shaft bearings of a measuring roll.

### BRIEF DESCRIPTION OF THE DRAWINGS

The present invention will be described in more detail in connection with the enclosed drawings.

FIG. 1 (Prior art) shows schematically a part of a rolling mill including a flatness measuring roll, a mill stand and a coiler according to the known art.

FIG. 2 (Prior art) shows a simplified block diagram for 5 measuring flatness according to the known art.

FIG. 3 illustrates a measuring roll.

FIG. 4 shows a simplified block diagram of a preferred embodiment of the system.

FIG. 5 is a simplified block diagram illustrating a preferred embodiment of the invention in a Flatness Determination Unit, FDU, of the system.

FIG. 6 is a signal diagram of a mean value force pulse U_{A}.

FIG. 7 contains five parallel signal diagram illustrating signals on five different channels in the system.

FIG. 8a is a block diagram illustrating an embodiment of a mean value determination circuit.

FIG. 8b is a block diagram illustrating another embodiment of a mean value determination circuit.

FIG. 9 is a simplified block diagram of a Flatness Determination Unit, FDU, of the system.

### DESCRIPTION OF THE PREFERRED EMBODIMENTS

In order to explain the invention, a rolling mill system 10 in the prior art will first be described in summary detail.

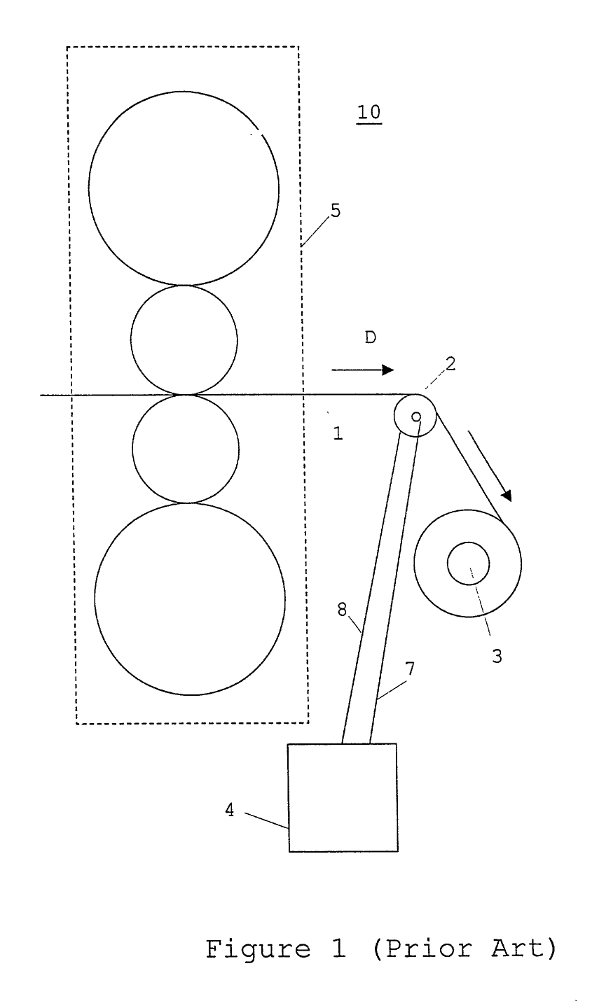

FIG. 1 (Prior art) shows a metal strip 1 passing through a mill stand 5 in a direction shown by an arrow D. Strip 1 passes over a measuring roll 2 to a coiler 3. Measurement signals from the load cells at the shaft bearings of the measuring roll 2 are connected to the flatness measuring unit 4 via a first measurement connection 7. Measuring devices on the measuring roll 2 are coupled to a flatness measuring unit 4 via a second measurement connection 8. Measurements of the strip corresponding to strip flatness are taken on exit from mill stand 5 by measuring roll 2 before coiling the strip on coiler 3.

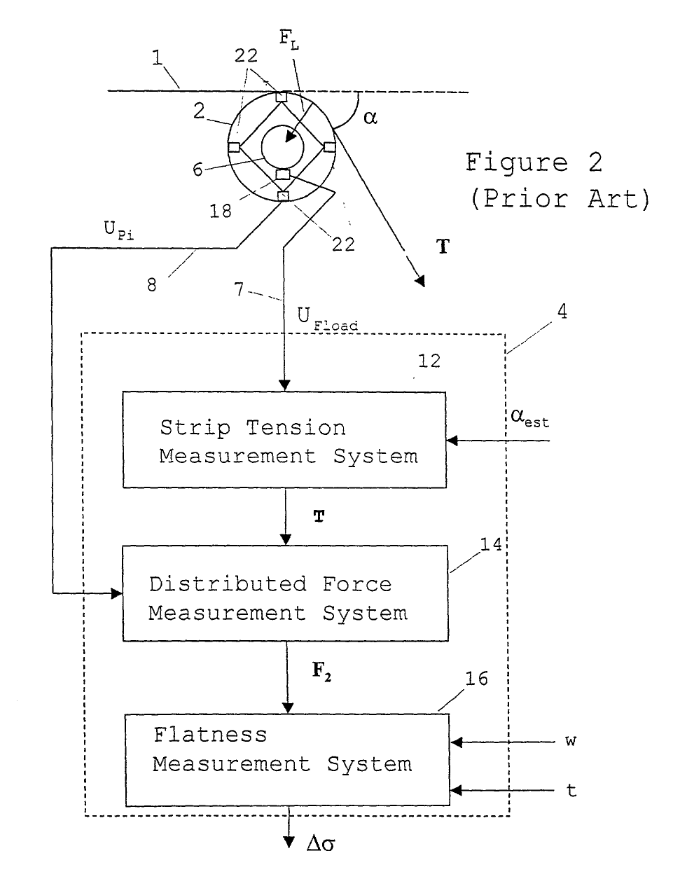

FIG. 2 (Prior art) shows a simplified block diagram for a known system for a flatness measuring unit 4. Said system comprises a Strip Tension Measurement System 12, a Distributed 5 Force Measurement System 14 and a Flatness Measurement System 16. The Strip Tension Measurement System (STMS) 12 is electrically connected to tensiometer load cells 18, which are fixed at the shaft bearings 6 of a measuring roll 2. The load cells 18 generates an input signal U_{Fload} that is transmitted over a first measurement connection 7 to the STMS. Said input signal U_{Fload} is a measure value corresponding to the force F_{L} of the strip against the measuring roll 2. For calculating Strip Tension T, a value for the current wrap angle α of the strip over the roll 2 is needed. The wrap angle α changes with the increased radius of the coil and the system uses an estimate value αₑₛₜ for the wrap angle. Said estimate value αₑₛₜ and load cell generated value U_{Fload} is used for calculating the strip tension T [N]. The calculated value T is transmitted to Distributed Force Measurement System (DFMS) 14. The measuring roll (2) has a number of measuring devices—force/pressure sensors/transducers—that are situated in a certain pattern on said roll. Each sensor/transducer generates a measurement output signal Uₚ₁ depending on the pressure of the flat sheet on to the transducer/sensor. The measurement signals are transmitted to the DFSM 14 via the second measurement connection 8. The DFSM 14 uses the strip tension T and each sensor/transducer signal for determining the Distributed Force F₂ per sensor/transducer. The determined value F₂ is transmitted to Flatness Measurement System (FMS) 16 for determining the Measured Flatness Δσ [N/mm²]. The width w and the thickness t, either a one- or multiple-dimensional vector, of the system has to be pre-loaded into the FMS.

Flatness per zone across the width of the strip during rolling is determined by means of the measuring roll 2, which has a number of force/pressure sensors that are situated in a certain pattern on said roll. A zone of the roll is a ring formed sector that is parallel with the rotational axle of the roller. Each measurement zone has at least one sensor/transducer and each sensor generates a measurement output signal depending on the pressure of the flat sheet on the sensor/transducer. The sensors 22 are distributed on the roll in a special pattern. The flatness of the strip 1 will be mapped in parallel lines across the strip perpendicular to the movement direction. If there is a bump or irregularity in the strip, the sensors that come in contact with the bump will register a signal amplitude that differs from the average value generated from other parts of the strip.

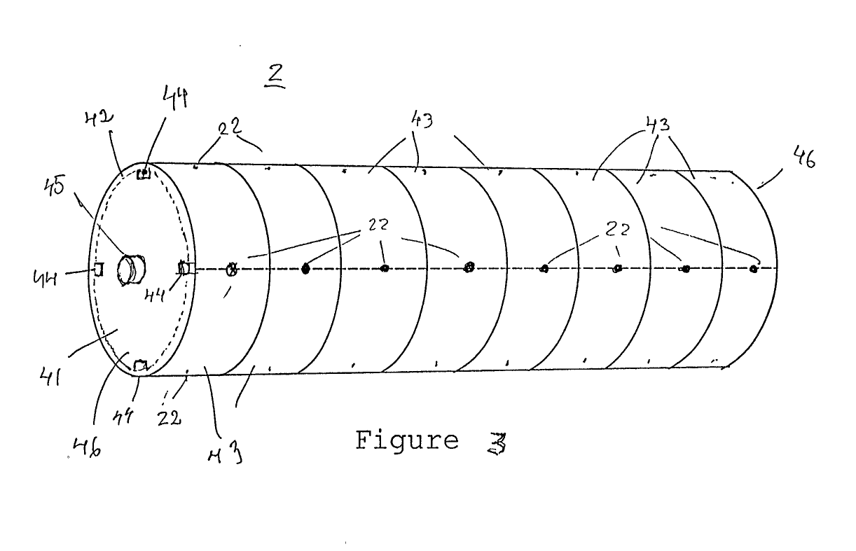

In FIG. 3 an embodiment of a measuring roll 2 is illustrated. It comprises a cylindrical central structure 41, a strip contact device 42 and shaft taps 45. The strip contact device 42 is tightly attached to the structure 41, both having a circular cross-section. The strip contact device 42 of the measuring roll 2 is divided into a number of measurement zones 43, i (i=1,2,3 . . . , n). Each zone 43 may correspond to one strip contact ring and all rings together will constitute the strip contact device 42. Each zone 43 is annular and comprises a number of sensors 22. The sensors 22 are sitting in parallel slots 44. The strip contact device 42 comprise metal rings that covers and protects the sensors. The end parts 46 of the measuring roll 2 have a shaft tap 45.

However, the invention, which will be described in the following, is not limited in its use to this described embodiment of measuring roll. The measuring roll 2 may have the force/pressure sensors distributed and organized in any known or unknown pattern on said roll and the measurement zones may have another distribution along the roll. The borders of a zone may cross the sensors.

One drawback with the prior art systems is that they make use of tensiometer load cells, which may be fixed at the shaft bearings of a measuring roll. The load cells generate an input signal U_{Fload} that is transmitted to a Strip Tension Measurement System. Said input signal U_{Fload} is a measure value corresponding to the force F_{L} of the strip against the measuring roll.

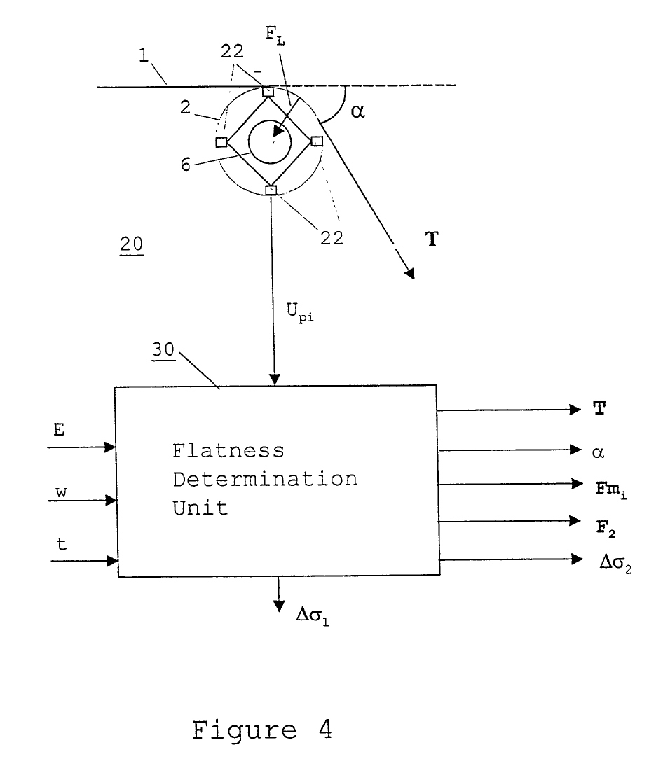

A flatness measurement system according to invention will now be described by means of FIG. 4. This system differs from the prior art system (described in FIG. 2). For example, the present invention does not involve any load cells at the shaft bearings of the measuring roll beside the force/pressure sensors distributed and organized in any known or unknown pattern on said roll.

In the following of this description measuring devices comprises force/pressure transducers/sensors/gauges of known types and will be denoted as a measuring device or force/pressure sensor or sensor.

A system 20 for measuring flatness of a strip 1 of rolled material comprises a measuring roll 2, which has a number of force/pressure sensors 22 that are situated in a certain pattern on said roll. Each sensor 22 generates an measurement output signal Uₚ₁ depending on the pressure of the flat sheet on to the sensor and a Wrap Angle α of the strip on the measuring roll 2. Said system 20 also comprises a Flatness Determination Unit 30, which is arranged for calculating a value corresponding the wrap angle α, based on said measurement output signals Uₚ₁ and, based thereon, the flatness of the strip.

A flatness determination signal may be derived from at least one measurement signal Uₚᵢ. As mentioned herein above, each separate measurement signal Uₚ₁ is generated by a corresponding measuring device of all measuring devices belonging to at least one of all measurement zones of a measuring roll and comprises one or more measurable values for calculating at least one of following quantities or vectors: strip tension vector T, wrap angle a, distributed force vector F₂, force vector Fₘᵢ, flatness vector Δσ₁ [N/mm²] and/or a corresponding quantity flatness vector Δσ₂ [I-unit]. The flatness determination signal is an input signal to a flatness determination unit for calculating at least one of said quantities or vectors. The flatness determination signal comprises a force component signal (U_{F1}) and said force component signal (U_{F1}) includes a train of electrical pulses.

A flatness determination signal may be derived by a number of said separate measurement signals Uₚ₁. Each of said measurement signals includes a train of electrical pulses, which are synchronized and combined to a flatness determination signal for calculating at least one of said quantities or vectors. Different known techniques for combining such signals are possible, for example integration, signal addition, signal subtraction, etc.

The generated measurement output signals Uₚ₁ or flatness determination signals are input signals to the Flatness Determination Unit 30 for calculating the quantities Wrap Angle α, the force vector Fₘᵢ for the corresponding measurement zone, Strip Tension T and Distributed Force F₂ on each sensor/transducer, which quantities are used for calculating the flatness Δσ₁ (Δσ₂ corresponding to relative strain in I-unit) by means of the Flatness Determination Unit 30. No tension measurement load cells are needed for determining the strip force on the measuring roll in the new invented system and all the above listed quantities are provided as output values. The flatness determination unit 30 receives as input, or stores, for calculating flatness of a moving strip at least one of following quantities or vectors: modulus of elasticity E, thickness vector t or width w of the strip.

A problem in this kind of systems having a measuring roll is sometimes that the measuring devices generates a high level of noise to the Flatness Determination Unit FDU. The generated signals Uₚ₁ comprises a force component signal U_{F1} that is used for the flatness determination and noise, here after referred to as a noise component signal or noise signal. The invented method and device that now will be described increases the signal-to-noise ratio.

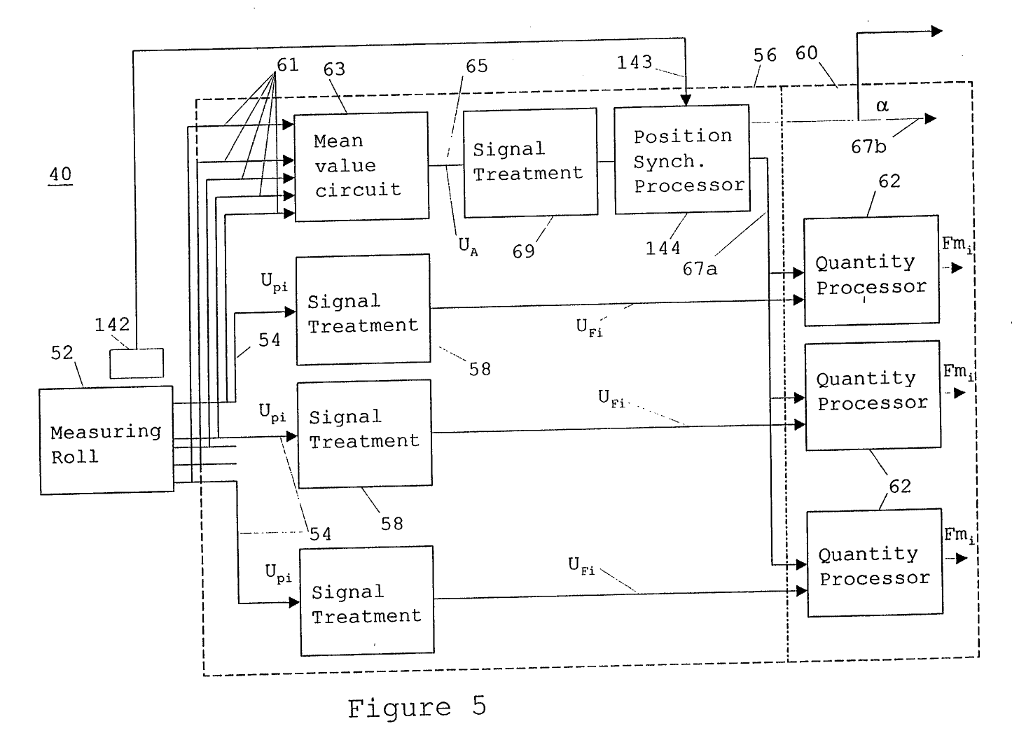

FIG. 5 illustrates a preferred embodiment of a system 40 for flatness determination comprising the invented device for increasing the signal-to-noise ratio. The system 40 comprises a measuring roll 52 connected to a flatness determination unit FDU 56, which comprises at least one part for signal processing 60. The FDU 56 comprises a number of signal treatment devices 58, preferably one device 58 for each signal channel 54, and a number of quantity processors 62, preferably one processor 62 for each signal channel, and the invented device that in this embodiment comprises a mean value circuit 63, a signal treatment device 69, a position synchronization processor 144 and a synchronization generator 142.

The object of the device is to improve the signal-to-noise ratio S/N in a system for measuring flatness of a strip of rolled material. Said system 40 comprises at least one signal 12 processor 60 for determining said flatness and a measuring roll 2 having a number of measuring devices for force/pressure registration. Said devices generate measurement output signals Uₚ₁ depending on the contact between the strip and the measuring roll, wherein said measurement output signal Uₚ₁ comprises a force component signal U_{F1} and a noise signal component. To achieve the object, the device comprises a position synchronization processor 144 that is arranged for determining a time length Tₜₒₜ based on the measurement output signals Uₚ₁, for generating a time slot having the determined time length Tₜₒₜ, for synchronizing said time slot to the appearance of a force component signal U_{F1} on an input of at least one quantity processor 62 and for controlling at least one quantity processor 62 to be open for registration of a incoming force component signals U_{F1} during said time slot and be closed until the next successive time slot appears.

The position synchronization processor 144 may be implemented of a microprocessor and applied software, stored in a memory connected to said microprocessor, the software adapted for determining a time length Tₜₒₜ based on the measurement output signals U_{P1}, for generating a time slot having the determined time length Tₜₒₜ, for synchronizing said time slot to the appearance of a force component signal U_{F1} on an input of at least one quantity processor 62 and for controlling at least one quantity processor 62 to be open for registration of a incoming force component signals U_{F1} during said time slot and be closed until the next successive time slot appears.

Said device may also comprise a mean value determining circuit 63 for generating a mean value signal U_{A} to the position synchronization processor 144 using the force component signals U_{F1}, which are generated within a time interval T_{ε}, from all or a number of said measurement output signals U_{Pi}.

The time parameter T_{ε} defines the maximum allowed time interval between force component signals U_{F1} to be used for generating a mean value signal U_{A}. If T_{ε} is set close to zero, only generated signals parallel in time will be used for each new mean value calculation. T_{ε}, is often determined by the pattern of measuring devices over the measuring roll.

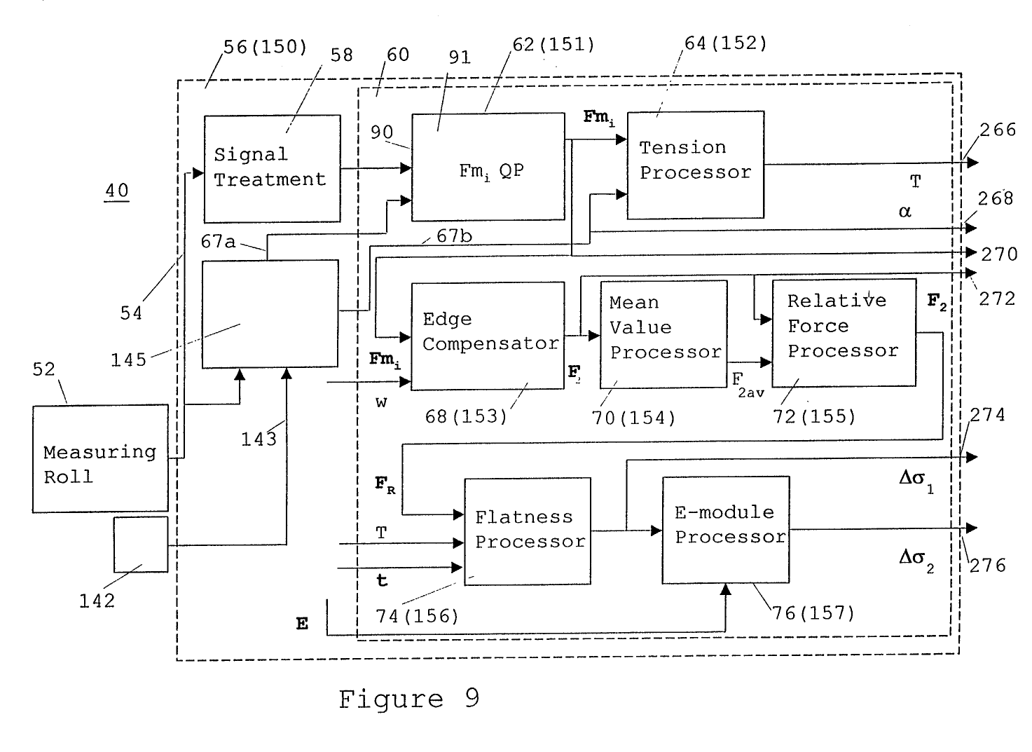

Each measurement zone i on the measuring roll 52 has a channel 54 for transmitting the measurement output signal U_{P1} from one of the zone sensors. Said channel is connected to a signal treatment device 58. Said signal treatment device 58 will be described in more detail in connection with FIG. 9. The signals Up, includes a force signal component U_{F1} and a noise signal. Sometimes the signal-to-noise ratio S/N is so low that ordinary signal treatment is enough for determining a wanted quantity or desired value of the generated signal U_{P1}. This problem is solved according to the invention by tapping a number of channels 54 or all channels 54 to a mean value circuit 63 for generating a mean value signal U_{A} on the output 65. The tapped signals U_{P1} are connected to the circuit 63 over conductors 61. In this embodiment the signal tapping is carried out before the signal treatment, but each channel may be tapped during the signal treatment of the signal. The circuit 63 will integrate the force and noise signal contributions from each signal. The S/N ratio will improve with a factor √2 if the number of contributing zones and signals are doubled. The mean value signal U_{A} is connected to a signal treatment device 69 to be signal treated in the same way as a sensor signal U_{P1} by a signal treatment device 58. The signal treated mean value signal U_{A} is electrically connected to a position synchronization processor 144 for determining a synchronizing pulse train on the control bus 67a. Each pulse of the train will have a pulse length Tₜₒₜ determined from the signal treated 14 mean value signal U_{A}. The pulse train is connected via the control bus 6′7a to the separate quantity processors 62 for use in the following signal processing as described in FIG. 9.

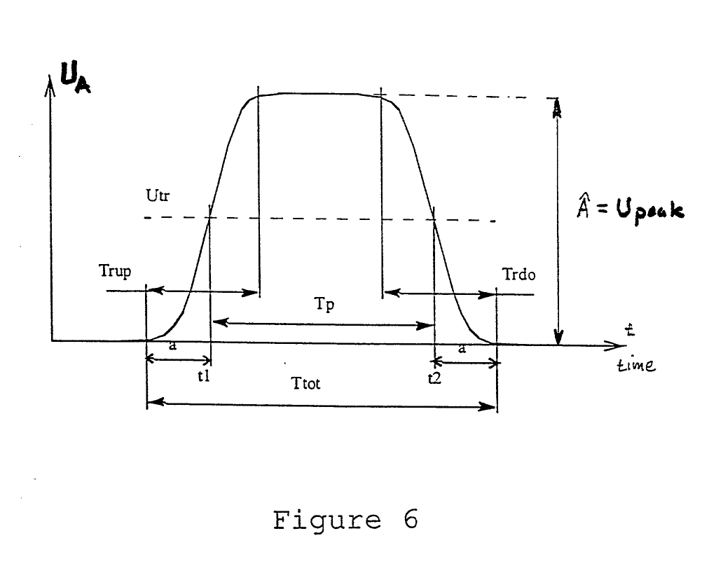

The mean value determining circuit 63 will produce mean value signals U_{A}. If the U_{P1} signals each comprise a train of force pulse components the mean value determining circuit 63 will produce a train of force pulses to the position synchronization processor 144. A mean value force pulse U_{A} is illustrated in FIG. 6. The signal has a number of characteristic values e.g. the amplitude A and the pulse width Tₜₒₜ. Said pulse width could be divided into different time intervals like Tᵣᵤₚ that is the rise time of said force pulse, the fall time T_{rdo} of the force pulse and the time interval T_{P} between the rise time Tᵣᵤₚ and the fall time T_{rdo}. The pulse width Tₜₒₜ will change when earlier mentioned wrap angle a changes. The wrap angle will change slowly with the slowly increasing radius of rolled material on the coiler 3.

The following description will concentrate on describing how the length value Tₜₒₜ is determined and calculated from a mean value force pulse U_{A} illustrated in FIG. 6. The position synchronizing processor 144 registers the amplitude and the amplitude variation as a function of time as signal characteristic values of the force signal U_{A} and detects a first and a second time point t₁ and t₂, respectively, when the force signal U_{A} passes a predetermined threshold value Uₜᵣ. In this embodiment, Uₜᵣ is chosen to correspond to half the peak value Uₚₑₐₖ, Uₜᵣ=½Uₚₑₐₖ. This threshold value will generally correspond to a time period exactly or close to half the rise time Tᵣᵤₚ, and if the pulse is symmetric, half the fall time T_{rdo}. The time parameters Tᵣᵤₚ and T_{rdo} depend on the geometry and the velocity of the measuring roll and are than considered as known or predetermined. In the figure half the rise time Tᵣᵤₚ and fall time Trdo are both defined as time length a. The position synchronizing processor 144 detects and determines the total pulse width Tₜₒₜ and the detected pulse width T_{P} of the force signal component U_{A} by means of two successive time points t₁ and t₂ and the time length a. The value of the parameter T_{P} is calculated, by use of the formula

T_{P}=t₂−t₁ (1)

and the value of the parameter Tₜₒₜ is calculated, by use of the formula

Tₜₒₜ=t₂−t₁+2a (2)

The position synchronizing processor 144 is designed to generate measuring time intervals, even called time slots, having the length Tₜₒₜ. On the output of the processor 144 a time slot could be implemented as and represented by a pulse having the length Tₜₒₜ or two short time pulses, one positive or one negative, defining the length Tₜₒₜ between them. Other representation of the length Tₜₒₜ is also possible. Said time slots is conducted from the output of the processor 144 via the control bus 67a to each one of the quantity processors 62 for controlling the registration periods of the incoming force pulses on each channel.

The position synchronization processor 144 can be used for determining the wrap angle α, that is transmitted to other parts of the system 40 over signal bus 67b. The wrap angle is calculated by determining characteristic value Tₚ, illustrated in FIG. 6. If the lap time of the measuring roll is Tₗₐₚ, is defined as

α=f(T_{P},Tₗₐₚ) (2)

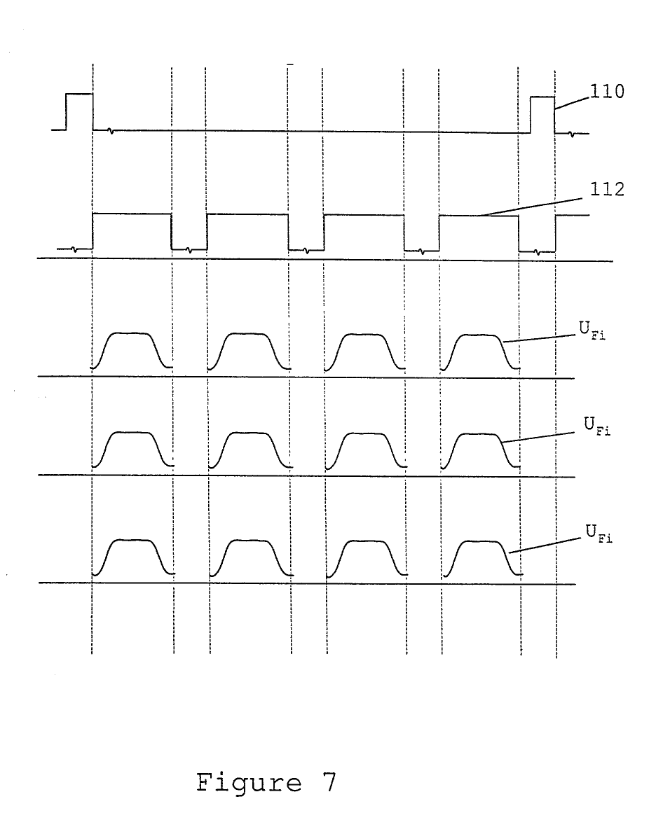

In FIG. 7 five parallel signal diagrams showing signals on five different channels in the system. The first signal diagram illustrates lap pulse signals on channel 143 between the pulse synchronization generator 142 and the position synchronization processor 144. A pulse will be generated and transmitted via channel 143 for every new lap of the measuring roll 52. The second signal diagram illustrates the time slots 112 on the signal conductor 67a from the position synchronization processor 144 to the quantity processors 62. The next three signals diagram illustrates force signal components U_{F1} on three different channels between each of the signal treatment devices 58 and the corresponding quantity processors 62.

The time slots have to be synchronized with the force pulses. This problem is solved by applying a synchronization pulse generator 142 at the measuring roll 52 and transmitting the generated synchronization pulses to a pulse input for the channel 143 on the position synchronization processor 144. The generator 142 generates pulses at certain positions of each lap, such as a predefined start point of each lap and/or just before each position where a measuring device is situated, of the measuring roll 52.

In a preferred embodiment of the invention the generator 142 registers the passing of a predefined position of the measuring roll as a start point of each new lap. For each passing of a start point a pulse will be transmitted to the position synchronization generator 144 that will reset and start a counting device in the processor. The processor 144 automatically divides each lap into a constant number of pulses. Each pulse will than correspond to a certain position of the measuring roll independent of the lap velocity. Each position of a measuring device along a lap will then correspond to a predefined position number of pulses, npi, counted from the start point and stored in memory of the processor 144. The position synchronization processor 144 will than generate a time slot with a length Tₜₒₜ, calculated and determined as described above, on the control bus 67 every time the number of pulses in the counter equals a position number npi. The length Tₜₒₜ corresponds to a number of pulses ntot and the processor 144 comprises a time slot length counter for counting the pulses controlling the length of the time slot. Correct synchronization and length of the time slots will improve the signal-to-noise ratio by opening each signal processor for registration just before a force pulse signal arrives and closing or blocking the signal registration means of the signal processors just after said force pulse signal has ended. As mentioned before, the measuring devices on the measuring roll generate a high level of noise when not being in contact with the strip and an integration of any noise components energy during the time periods between the pulses is prevented.

The method for improving the signal-to-noise ratio S/N in a system for measuring depending on the contact between the strip 1 and the measuring roll 2;

generating a mean value signal U_{A} for the measurement output signals U_{Pi};

determining a time length Tₜₒₜ, based on the mean value 30 signal U_{A};

generating a time slot having the time length Tₜₒₜ;

synchronizing said time slot to the appearance of a force component U_{Fi} on an input of at least one quantity processor 62;

controlling at least one quantity processor 62 to be open for registration of the force component U_{F1} during said time slot and be closed until the next successive time slot appears.

The invented method is described in more detail according to claims 1-6.

The mean value determining circuit 63 may be implemented of a microprocessor and applied software, stored in a memory connected to said microprocessor, the software adapted for calculating a mean value from a number of signals U_{Pi}.

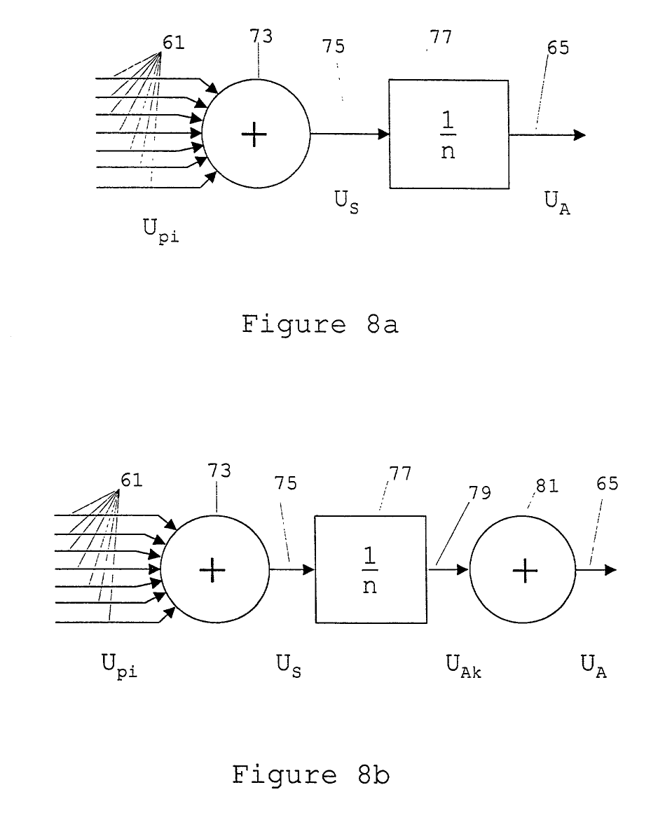

In FIG. 8a there is illustrated an embodiment of a mean value determining circuit 63. Said circuit 63 generates a mean value signal U_{A} from all or a number of said signals U_{P1} generated within a small time interval Tε. Said time interval Tε for registration results in registration of measurement output signals U_{P1} from mainly parallel placed measuring devices, for example sitting in a longitudinal duct of the measuring roll (see FIG. 4). A formula for determining the mean value signal U_{A}

Looks as follow:

$${U}_{A} = 1 / n \cdot {\sum }_{i = 1}^{n} {U}_{p i}$$

Said mean value determining circuit 63 comprises at least one summation circuit 73 for adding a number n of signals U_{P1}, transmitted via inputs 61 and generated within said small time period Tε. The summation circuit 73 produces a summation signal Uₛ, which is transmitted over the connection 75 to a dividing circuit 77 for dividing U_{S} with an integer n, where n equals the number of added signals U_{P1} to the summation circuit 73. The dividing transmitted over the connection 75 to a dividing circuit 77 for dividing U_{S} with an integer n, where n equals the number of added signals U_{P1} to the summation circuit 73. The dividing circuit 77 produces a mean value signal U_{A}. The mean value signal U_{A} is connected to a position synchronization processor 144 for determining a measurement pulse train. The pulse train is connected to the separate signal processors 60 for use in the succeeding signal processing.

Another embodiment of a mean value determining circuit 63, illustrated in FIG. 8b, comprises at least one second summation circuit 81 for storing and adding a number k of consecutive mean value signals U_{A} to each other for further improvement of the S/N ratio. The second summation circuit 81 is connected to the dividing circuit 77 via the connection 79. The mean value signal U_{A} is connected to a position synchronization processor 144 for determining a measurement pulse train. The pulse train is connected to the separate quantity processors 62 for use in the succeeding signal processing.

In the following the Flatness Determination Unit, FDU, of a system 40 according to the invention will be described with reference to FIG. 9. As long as each zone and corresponding output signals are treated separately and no mixing or integration over the zones is performed by the system all measurement zones, channels and signal paths of the system are parallel and designed exactly in the same way. Therefore, in the following only one signal path of the measurement system will be described.

Every time a sensor is influenced by the strip passing a voltage or/and current is generated. The input signal to the sensor has a frequency f_{c}. When a force is applied to the measuring roll the input signal becomes a carrier wave that is modulated in proportion to the applied force. The signal may be sampled before it is transmitted to the FDU.

The FDU has clock circuits (not shown) generating clock pulses for synchronisation of the different blocks and processes of the system.

Measurement signals, analogue or digital, will be transmitted from the measurement zones of the measuring roll 52 via the channels 54 to the FDU 56. The FDU 56 will have one input port and one signal treatment device 58 for each channel 54. In this embodiment, the force signal is Amplitude Modulated (AM) on a carrier wave having the carrier frequency f_{c}. However, a person skilled in the art can chose and apply any transmission method, such as any other modulation method or a method wherein no modulation is done.

One of the tasks of the signal treatment device 58 is to demodulate the input signal. Other signal operations carried out by the signal treatment device 58 are filtering and rectifying.

By multiplying an AM input signal with a rectification signal the input signal will be demodulated. After demodulation, the signal comprises both the force signal component U_{F1}, a DC component and the carrier wave. The only useful signal is the force signal component U_{Fi}. A standard filter will remove the components of no interest. The signal treatment is finished and the force signal component U_{F1} is forwarded to the signal processing unit 60 or, shorter, signal processor, of the FDU 56.

The method and signal processing unit 60 for determining different quantities out of the signal treated force signal component U_{F1} will now be described in more detail.

The output of the signal treatment device 58 is a force signal component U_{F1} consisting of force pulses. The invented device 145, comprising a mean value circuit 63, a signal treatment device 69 and a position synchronization processor 144 generates time slots, as described in FIG. 5, and the time slots are transmitted via the control bus 67a to a quantity processor 62 and controls the quantity processor 62 to be open for registration of an incoming force component signal U_{F1} during said time slot and be closed until the next successive time slot appears. Each pulse of the force signal component contains information about the force and wrap angle. The amplitude Uₚₑₐₖ of each pulse depends on the force against the signal generating sensor 22 and the length of each pulse depends on the wrap angle α and the strip velocity. The wrap angle α determines the length of the strip contact area against the measuring roll and the velocity determines the time for a sensor to pass that area.

The first step 151 is to extract and determine the force vector Fₘ₁ for the as signals to a tension processor block 64 that, in step 152, calculates the tension T [N] over the strip by generating the sum of force vectors Fₘᵢ for all measuring zones. A value for the wrap angle α is provided by the invented device 145 via the bus 67b connected to the tension processor block 64. Said sum is divided by the Sinus value of the wrap angle α, in accordance with the formula

T=ΣFₘᵢ/2 (Sin α/2)

The quantities T, α, and Fₘᵢ are forwarded in digital form as signals to separate output ports 266, 268 and 270 for further purposes in the rolling mill system, e.g. display. T is also transmitted to a Flatness Processor 74 that will be described further on in this description. The force vector Fₘᵢ is forwarded to an edge compensator 68 in the next step 153. Said device/block 68 introduces the width w of the strip and if necessary, the strip position on the measuring roll. The width of the strip varies and for determining the correct flatness value and tension and force distributions, the width variation must be considered. The result of the this calculation is the force distribution vector F₂ [N/mm]. The digital signal representing the quantity F₂ is transmitted to an average generator block 70, a relative force processor block 72 and an output port 272. In the following two steps, 154 and 155, an average distribution force F₂ₐᵥ is generated by means of the average generator block 70 and then, the second step 156, calculate the relative force

F_{R}=(F₂−F₂ₐᵥ)/F₂ₐᵥ

by means of a scalar generator block 72. The flatness vector Dal [N/mm2] is then calculated by use of a flatness vector generator block 74 in the following step 156. The thickness vector t is used in this step 156 as an input to the generator 74. The flatness vector Δσ₁ is calculated by use of the formula

Δσ₁=F_{R}−(T/(w·t))

One further step 157 may be taken—that is to transform the flatness vector Δσ₁ [N/mm²] to a corresponding quantity flatness vector Δσ₂ [I-unit]. The flatness vector Δσ₁ [N/mm²] is One further step 157 may be taken—that is to transform the flatness vector Δσ₁ [N/mm²] to a corresponding quantity flatness vector Δσ₂ [I-unit]. The flatness vector Δσ₁ [N/mm²] is forwarded to a E-module processor block/step 76/157 and the flatness vector Δσ₂ is generated as an output 280. By dividing the flatness vector Δσ₁ [N/mm²] with the modulus of elasticity E, the corresponding dimensionless flatness vector Δσ₂ is generated. The FDU 56 has a flatness vector Δσ₁ output 274. The quantities Δσ₁ and Δσ₂ are forwarded in digital form as signals to said output ports 274 and 276 for further purposes in the rolling mill system, e.g. control and display purposes. The method is repeated each time as new information from the measuring devices is received by the FDU 56.

The steps, blocks and the devices discussed in the embodiment according to FIG. 5 may be implemented as hardware circuits or as software routines in a processor or central processing unit, CPU. Therefore, the invention also is implemented as a computer program product for improving the signal-to-noise ratio (S/N) in a system for measuring flatness of a strip of rolled material, the computer program product contains computer program code elements or software routines that when run on a computer or processor causes said computer or processor to carry out the steps of claims 1-6.

A flatness determination input signal derived from at least one measurement signal Uₚᵢ, wherein each measurement signal Uₚ₁ is generated by one measuring device of the zones of a measuring roll and comprises one or more values for calculating and strip tension vector T, wrap angel α, distributed force vector F₂, force vector Fₘᵢ, flatness vector Δσ₁ [N/mm ²] and/or a corresponding quantity flatness vector Δσ₂ [I-unit].

The present invention is not limited to the above-described preferred embodiments. Various alternatives, modifications and equivalents may be used. Therefore, the above embodiments should not be taken as limiting the scope of the invention, which is defined by the appended claims.

1. A method for improving the signal-to-noise ratio (S/N) in a system for measuring flatness of a strip (1) of rolled material, said system comprising at least one signal processor (60) for determining said flatness and a measuring roll (2, 52), having a number of measuring devices for force/pressure registration, each said device generating a measurement output signals (Uₚ₁) depending on the contact between the strip (1) and the measuring roll (2, 52), wherein each measurement signal (Uₚ₁) comprises a force component signal (U_{F1}) and a noise signal component, said method comprising the step of:
generating measurement output signals (Up,) by means of each measuring device depending on the contact between the strip (1)) and the measuring roll (2); characterized in that, said method comprises the following steps:
determining a time length (Tₜₒₜ), based on the measurement output signals (Uₚᵢ);
generating a time slot having the determined time length (Tₜₒₜ);
synchronizing said time slot to the appearance of a force component (U_{F1}) on an input of at least one quantity processor (62) of said signal processor (60);
controlling at least one quantity processor (62) to be open for registration of an incoming force component signal (U_{F1}) during said time slot and be closed until the next successive time slot appears.

2. A method according to claim 1, characterized in that, said method comprises the steps:
generating a mean value signal (U_{A}) using the force component signals (U_{F1}), which are generated within a time interval (T_{ε}), from all or a number of the measurement output signals (Uₚ₁);
determining a time length (Tₜₒₜ), based on the mean value signal (U_{A}).

3. A method according to claim 2, characterized in that, said method comprises the steps:
adding a number n, n is a positive integer, of measurement output signals(U_{P1}) generated within a small time period (T_{ε}) to a mean value determining circuit (63) comprising at least one summation circuit (73) for producing a summation signal (U_{S});
connecting said summation signal (Us) to a dividing circuit (77) for dividing (Us) with an integer n, where n equals the number of added signals (Uₚ₁) to the summation circuit (73);
producing a mean value signal (U_{A}) by said dividing circuit (77).

4. A method according to claim 2, characterized in that, said method comprises the step:
adding a number n, n is a positive integer, of measurement output signals (Uₚᵢ) generated within a time period (T_{ε}) to the mean value determining circuit (63) comprising a microprocessor and applied software, stored in a memory that is connected to said microprocessor, wherein the software is adapted for calculating a mean value from a number of measurement output signals (Uₚ₁).

5. A method according to claim 3 or 4, characterized in that, said method comprises the step:
storing and adding, to at least one second summation circuit (81), a number k, k is a positive integer, of consecutive mean value signals (U_{A}) to each other for further improvement of the S/N ratio.

6. A method according to claim 5, characterized in that, the method comprises the step:
signal treating of the mean value signal (U_{A}) by means of filtering and/or demodulating and/or rectifying the mean value (U_{A}).

7. A device (145) for improving the signal-to-noise ratio (S/N) in a system for measuring flatness of a strip (1) of rolled material, said system comprising at least one signal processor (60) for determining said flatness and a measuring roll (2), having a number of measuring devices for force/pressure registration, each said device generating a measurement output signals (Uₚ₁) depending on the contact between the strip and the measuring roll, wherein said measurement output signal (Uₚ₁) comprises a force component signal (U_{F1}) and a noise signal component, characterized in that the device (145) comprises a position synchronization processor (144) that is arranged for determining a time length (Tₜₒₜ) based on the measurement output signals (U_{P1}), for generating a time slot having the determined time length (Tₜₒₜ), for synchronizing said time slot to the appearance of a force component signal (U_{F1}) on an input of at least one quantity processor (62) of said signal processor (60) and for controlling at least one quantity processor (62) to be open for registration of a incoming force component signals (U_{F1}) during said time slot and be closed until the next successive time slot appears.

8. A device according to claim 7, characterized in that, said device (145) comprises a mean value determining circuit (63) generating a mean value signal (U_{A}) to the position synchronisation processor (144) using the force component signals (U_{F1}), which are generated within a time interval (Tε), from all or a number of said measurement output signals (U_{P1}).

9. A device according to claim 8, characterized in that, said mean value determining circuit (63) comprises at least one summation circuit (73) for adding a number n, n is an positive integer, of measurement output signals (U_{P1}) generated within said time period (Tε), said summation circuit (73) producing a summation signal (Uₛ), which is connected to a dividing circuit (77) for dividing (Uₛ) with an integer n, where n equals the number of added signals (U_{P1}) to the summation circuit (73), said dividing circuit (77) producing a mean value signal (U_{A}).

10. A device according to claim 8, characterized in that, said mean value determining circuit (63) comprises a microprocessor and applied software, stored in a memory connected to said microprocessor, the software adapted for calculating a mean value from a number of signals (Uₚ₁).

11. A device according to claim 9 or 10, characterized in that, said device (145) comprises at least one second summation circuit (81) for storing and adding a number k, k is a positive integer, of consecutive mean value signals (U_{A}) to each other for further improvement of the S/N ratio.

12. A device according to claim 11, characterized in that, the device (145) comprises a signal treatment device (58) comprising at least one filter device or at least one demodulating device or at least one rectifying device for signal treatment of the mean value signal (U_{A}).

13. A device according to any of the claims 9-12, characterized in that, connecting said mean value signal (U_{A}) to the position synchronisation processor (144) for determining the wrap angle (a) which is used in the system (40) for determining the flatness.

14. The use of a device (145) according to any of the claims 7 to 13 in a rolling mill.

15. A computer program product containing computer program code elements or software routines that when run on a computer or processor causes said computer or processor to carry out the steps of claims 1-6.

16. A flatness determination signal for improving the signal to-noise ratio (S/N) in a system for measuring flatness of a strip (1) of rolled material and derived from at least one measurement signal (Uₚ₁), characterized in that each separate measurement signal (Uₚ₁) is generated by a corresponding measuring device of all measuring devices belonging to at least one of all measurement zones of a measuring roll and comprises one or more measurable values for calculating at least one of following quantities or vectors: strip tension vector T, wrap angel α, distributed force vector F₂, force vector Fₘᵢ, flatness vector Δσ1[N/mm²] and/or a corresponding quantity flatness vector Δσ₂[I-unit].

17. A flatness determination signal according to claim 16, characterized in that said flatness determination signal is input signal to a flatness determination unit for calculating at least one of said quantities or vectors.

18. A flatness determination signal according to claim 17, characterized in that said flatness determination signal comprises a force component signal (U_{F1}).

19. A flatness determination signal according to claim 18, characterized in that said force component signal (U_{Fi}) includes a train of electrical pulses.

20. A flatness determination signal according to any of claims 16-19, in that a number of said separate measurement signal (Uₚ₁), each including a train of electrical pulses, are synchronized and combined to a flatness determination signal for calculating at least one of said quantities or vectors.

21. A system for measuring flatness of a strip (1) of rolled material, said system comprises at least one signal processor (60) for determining said flatness and a measuring roll (2), having a number of measuring devices for force/pressure registration, said devices generating measurement output signals (Uₚ₁) depending on the contact between the strip and the measuring roll, wherein said measurement output signal (Uₚ₁,) comprises a force component signal (U_{F1}) and a noise signal component, characterized in the system comprises a device (145) for improving the signal-to-noise ratio (S/N), wherein said device (145) comprises a position synchronisation processor (144) that is arranged for determining a time length (Tₜₒₜ) based on the measurement output signals (U_{P1}), for generating a time slot having the determined time length (Tₜₒₜ), for synchronising said time slot to the appearance of a force component signal (U_{F1}) on an input of at least one quantity processor (62) of said signal processor (60) and for controlling at least one quantity processor (62) to be open for registration of a incoming force component signals (U_{F1}) during said time slot and be closed until the next successive time slot appears.

22. A system according to claim 21, characterized in that, said device (145) comprises a mean value determining circuit (63) generating a mean value signal (U_{A}) to the position synchronisation processor (144) using the force component signals (U_{F1}), which are generated within a time interval (Tε), from all or a number of said measurement output 5 signals (Uₚ₁).

23. A system according to claim 22, characterized in that, said mean value determining circuit (63) comprises at least one summation circuit (73) for adding a number n, n is an positive integer, of measurement output signals (U_{P1}) generated within said time period (Tε), said summation circuit (73) producing a summation signal (Us), which is connected to a dividing circuit (77) for dividing (Us) with an integer n, where n equals the number of added signals (U_{P1}) to the summation circuit (73), said dividing circuit (77) producing a mean value signal (U_{A}).

24. A system according to claim 22, characterized in that, said mean value determining circuit (63) comprises a microprocessor and applied software, stored in a memory connected to said microprocessor, the software adapted for calculating a mean value from a number of signals (Uₚ₁).

25. A system according to claim 23 or 24, characterized in that, said device (145) comprises at least one second summation circuit (81) for storing and adding a number k, k is a positive integer, of consecutive mean value signals (U_{A}) to each other for further improvement of the S/N ratio.

26. A system according to claim 21, characterized in that, the device (145) comprises a signal treatment device (58) comprising at least one filter device or at least one demodulating device or at least one rectifying device for signal treatment of the mean value signal (U_{A}).

27. A system according to any of the claims 21-26, in that, connecting said mean value signal (U_{A}) to the position synchronisation processor (144) for determining the wrap angle (α), which is used in the system (40) for determining the flatness.
